(19) United States
(12) Patent Application Publication
(10) Pub. No.: US 2026/0329716 A1
(43) Pub. Date: Oct. 22, 2026

(54) TRACE LOG FOR TRACKING OF MULTI-LAYER COMMAND PROCESSING

(71) Applicant: Micron Technology, Inc., Boise, ID (US)

(72) Inventors: Jun Wang, Shanghai (CN); Huachen Li, Shanghai (CN); De Hua Guo, Shanghai (CN); Jia Ling Pan, Shanghai (CN)

(21) Appl. No.: 19/468,888

(22) Filed: Feb. 3, 2026

Related U.S. Application Data
(60) Provisional application No. 63/761,463, filed on Feb. 21, 2025.

(51) Int. Cl. G06F 11/34; G06F 11/30; G06F 11/32

(52) U.S. Cl. CPC G06F 11/3476; G06F 11/3027; G06F 11/323

(57) ABSTRACT

Methods, systems, and devices for trace log for tracking of multi-layer command processing are described. A trace log may be implemented at the memory system to collect operation history and command information of the memory system. For example, a host system and a memory system may communicate commands via various layers of different interfaces of the memory system. In response to communicating the commands, the memory system may store data associated with the commands at the transport layer and data associated with commands at the command interconnect layer in a trace log of the memory system according to a same timing. In the case that a trigger is detected, the memory system may flush the trace log to non-volatile memory of the memory system such that the data of the trace log may be retained and later used in diagnostic or recovery operations.

### CROSS REFERENCE

The present Application for Patent claims priority to U.S. Patent Application No. 63/761,463 by Wang et al., entitled “TRACE LOG FOR TRACKING OF MULTI-LAYER COMMAND PROCESSING,” filed Feb. 21, 2025, which is assigned to the assignee hereof, and which is expressly incorporated by reference in its entirety herein.

### TECHNICAL FIELD

The following relates to one or more systems for memory, including trace log for tracking of multi-layer command processing.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIGS. 1 and 2 show examples of systems that support trace log for tracking of multi-layer command processing in accordance with examples as disclosed herein.

FIG. 3 shows an example of a protocol stack that supports trace log for tracking of multi-layer command processing in accordance with examples as disclosed herein.

FIG. 4 shows an example of a process flow that supports trace log for tracking of multi-layer command processing in accordance with examples as disclosed herein.

FIG. 5 shows a block diagram of a memory system that supports trace log for tracking of multi-layer command processing in accordance with examples as disclosed herein.

FIG. 6 shows a flowchart illustrating a method or methods that support trace log for tracking of multi-layer command processing in accordance with examples as disclosed herein.

### DETAILED DESCRIPTION

Some memory systems (e.g., universal flash storage (UFS) devices) may use error logs to keep track of types of error that may occur at the memory system and various commands received from a host system. For example, a memory system may include a command log (e.g., a small computer system interface (SCSI) log) to track error types and commands. In the case that the memory system detects an error, the memory system may store details regarding the error to the logs, such that the memory system or the host system may use the stored data in various recovery operations. While storage of error logs and other related system errors (e.g., storage command interface errors, a UFS interconnect (UIC) layer error) at the memory system (e.g., and the host system) may be beneficial in recovering data at the memory system, some types of information may not be stored. For example, while the memory system may store command log data and storage command interface error information, it may be difficult to correctly align storage command interface errors (e.g., SCSI command errors) or UIC layer errors with corresponding operations at or below the transport layer (e.g., unified protocol (UniPro) layer(s)) when determining causes of errors at the memory system or when performing recovery operations. In some examples, the memory system may compare data logs stored at the associated host system and command logs at the memory system to detect problems that may lead to errors at the memory system (e.g., at a storage command interface of the memory system). However, comparing data logs may supply the memory system with minimal information and thus the memory system may be unable to map various commands with operations during error detection or may use a large quantity of time during recovery operations.

To increase recovery speed and efficiency at the memory system, a multi-layer trace log may be implemented at the memory system to collect operation history and command (e.g., and response) information of the memory system. For example, a host system and a memory system may communicate commands via various layers (e.g., a transport layer, a command interconnect layer) of different interfaces (e.g., a storage command interface, a communication interface) of the memory system. In response to communicating the commands, the memory system may store information associated with the commands at a layer of the communication interface (e.g., the transport layer) and information associated with commands at the storage command interface (e.g., command interconnect layer) in a trace log of the memory system according to a same timing (e.g., based on a clock of the communication interface). In the case that a trigger is detected, the memory system may flush the trace log to non-volatile memory of the memory system such that the data of the trace log may be retained and later used in diagnostic or recovery operations.

In addition to applicability in memory systems as described herein, techniques including use of a trace log for tracking of multi-layer command processing may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, techniques including use of a trace log for tracking of multi-layer command processing may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by increasing recovery responses which may reduce electronic waste and extend the life of electronic devices and thereby reducing electronic waste, among other benefits.

Features of the disclosure are illustrated and described in the context of systems, devices, and circuits. Features of the disclosure are further illustrated and described in the context of process flows, block diagrams, and flowcharts.

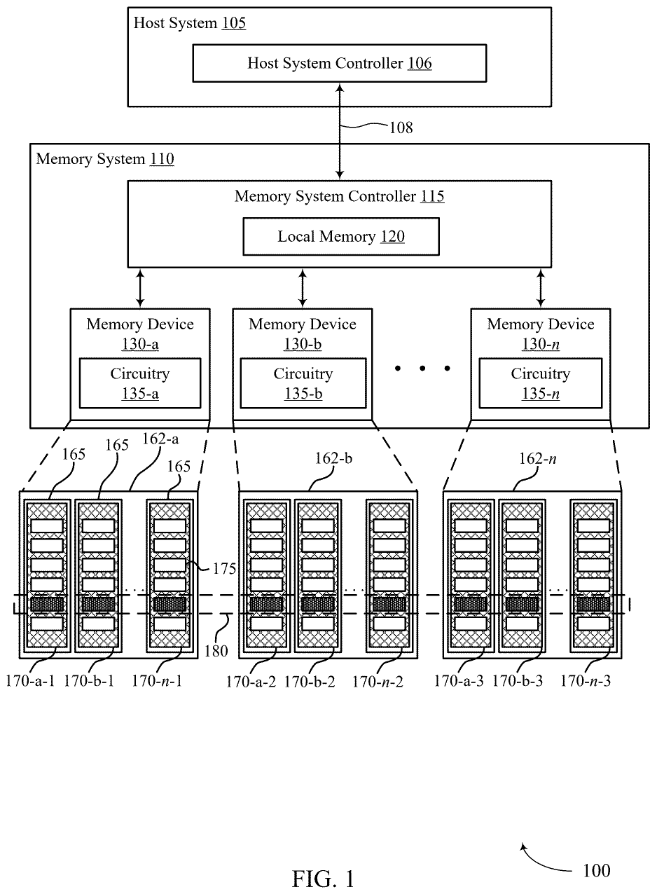

FIG. 1 shows an example of a system 100 that supports trace log for tracking of multi-layer command processing in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a UFS device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 108. The host system 105 and the memory system 110 may, in some cases, be configured to communicate via the interface 108 using an associated protocol (e.g., to exchange or otherwise communicate control, address, data, and other signals between the memory system 110 and the host system 105). Examples of interface 108 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), and a Low Power Double Data Rate (LPDDR) interface. In some examples, multiple such interfaces may be included in or otherwise supported between a host system controller 106 of the host system 105 and a memory system controller 115 of the memory system 110 (e.g., interface 108 may support communication via multiple protocol layers).

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable read-only memory (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n. The circuitry 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). Each die 162 may include one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases concurrent operations may be performed on different planes 165 or on different blocks 170. For example, concurrent operations may be performed on memory cells within different blocks 170 so long as the different blocks 170 are in different planes 165. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come different planes 165 of different memory dies 162. In some examples, a virtual block may include a respective block from each plane 165 (e.g., a block 170 from each plane 165) of one or more memory dies 162. In some cases, a virtual block may include blocks 170 from different memory devices 130 (e.g., including blocks in one or more planes 165 of memory device 130-a, memory device 130-b, and memory device 130-n). In some cases, the blocks 170 within a virtual block may have the same block address within their respective planes 165 (e.g., block 170-a-1 may be “block 0” of a first plane of die 162-a, block 170-a-2 may be “block 0” of a first plane of die 162-b, a block 170-a-3 may be a “block 0” of a first plane of die 162-n, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the circuitry 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the circuitry 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or circuitry 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry. An example of a managed memory system is a managed NAND (MNAND) system.

The memory system 110 (e.g., UFS devices) may use error logs to keep track of types of error that may occur at the memory system 110 and various commands received from a host system 105. For example, a memory system 110 may include a command log (e.g., a SCSI log) to track error types and commands. In the case that the memory system 110 may detect an error, the memory system 110 may store details regarding the error to the logs, such that the memory system 110 or host system 105 may use the stored data in various recovery operations. While storage of error logs and other related system errors (e.g., storage command interface errors, a UIC layer error) at the memory system 110 (e.g., and the host system 105) may be beneficial in recovering data at the memory system 110, some types of information may not be stored. For example, while the memory system 110 may store command log data and storage command interface error information, it may be difficult to correctly align storage command interface errors (e.g., SCSI command errors) or UIC layer errors with corresponding operations at or below the transport layer (e.g., a UniPro layer(s)) when determining causes of errors at the memory system 110 or when performing recovery operations. In some examples, the memory system 110 may compare data logs stored at the associated host system 105 and command logs at the memory system 110 to detect problems that may lead to errors at the memory system 110 (e.g., at a storage command interface of the memory system 110). However, comparing data logs may supply the memory system 110 with minimal information and thus the memory system 110 may be unable to map various commands with operations during error detection or may use a large quantity of time during recovery operations.

To increase recovery speed and efficiency at the memory system 110, a multi-layer trace log may be implemented at the memory system 110 to collect operation history and command (e.g., and response) information of the memory system 110. For example, a host system 105 and a memory system 110 may communicate commands via various layers (e.g., a transport layer, a command interconnect layer) of different interfaces (e.g., a storage command interface, a communication interface) of the memory system 110. In response to communicating the commands, the memory system 110 may store information associated with the commands at a layer of the communication interface (e.g., the transport layer) and information associated with commands at the storage command interface (e.g., command interconnect layer) in a trace log of the memory system 110 according to a same timing (e.g., based on a clock of the communication interface). In the case that a trigger is detected, the memory system 110 may flush the trace log to non-volatile memory of the memory system 110 such that the data of the trace log may be retained and later used in diagnostic or recovery operations.

The system 100 may include any quantity of non-transitory computer readable media that support trace log for tracking of multi-layer command processing. For example, the host system 105 (e.g., a host system controller 106), the memory system 110 (e.g., a memory system controller 115), or a memory device 130 (e.g., circuitry 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by circuitry 135), may cause the host system 105, the memory system 110, or the memory device 130 to perform associated functions as described herein.

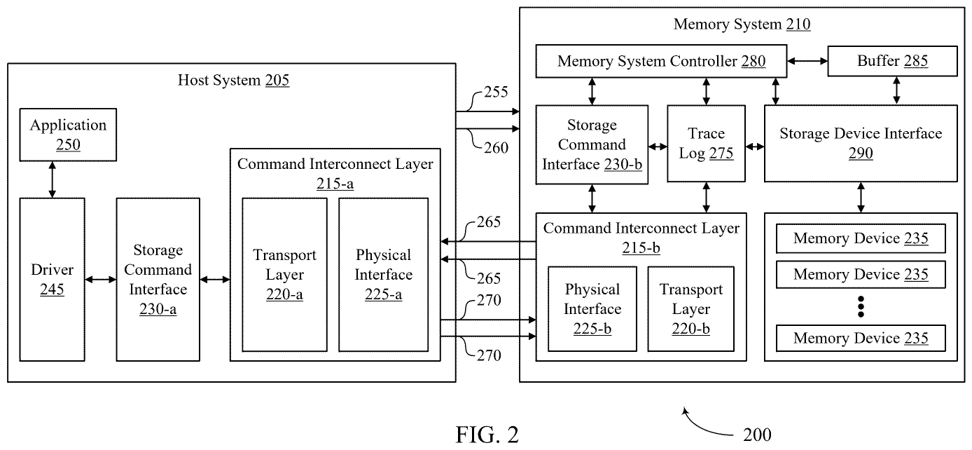

FIG. 2 shows an example of a system 200 that supports trace log for tracking of multi-layer command processing in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210, the memory system controller 280, and the host system 205 may be examples of the memory system 110, the memory system controller 115, and the host system 105, respectively.

The memory system 210 and the host system 205 may communicate commands and associated data via storage command interfaces 230. For example, the host system 205 may transmit an access command (e.g., a read command, a write command) from an application 250 of the host system 205 to the memory system via a driver 245 and via the storage command interface 230-a of the host system 205. In communicating the access command, the host system 205 may communicate the access command via one or more layers and interfaces of the command interconnect layer 215-a of the host system 205. In some examples, the command interconnect layers 215 may be examples of a UIC layer. For example, the command interconnect layer 215-a may include a transport layer 220-a and a physical interface 225-a that may operate according to one or more command protocols specific to the various layers and interfaces. In some examples, the transport layer 220 may support multiple logical data streams (e.g., from one or more applications 250), and may be configured to accept data packets, divide each data packet into smaller portions (e.g., if beneficial or necessary), and transmit the smaller data packets to a next layer or interface. The physical interface 225 of the command interconnect layer 215 may be configured to communicate symbols associated with data packets and manage timing of symbols according to a clock at the physical interface 225. The physical interface 225 may support multiple speeds (e.g., gears), where higher speeds may support enhanced modulation and clock speeds. During transmission of the access command via the command interconnect layer 215-a, the host system 205 may store details of the transactions (e.g., command reception information, command response data) associated with the access command at the various layers and interfaces of the command interconnect layer 215-a in one or more logs.

The host system 205 and the memory system 210 may communicate symbols via various data channels 265 of the physical interface 225 (e.g., physical lanes such as differential signaling) and according to a reference clock 260 and a reset signal 255. For example, the host system 205 may communicate symbols to the memory system 210 for various operations via the data channels 270 according to the reference clock 260. Similarly, the memory system 210 may communicate symbols to the host system 205 during various operation via the data channels 265 according to the reference clock 260.

The memory system 210 may include various components to aid in access operations. For example, the memory system 210 may include a memory system controller 280 that may assist in managing data stored in the memory devices 235 (e.g., for storing data, for retrieving data, for determining memory locations in which to store data and from which to retrieve data) in response to receiving an access command from the host system 205. The memory system 210 may also include a storage command interface 230-b for communication with the host system 205 and a command interconnect layer 215-b that may support translation of access commands between the storage command interface 230-b and the transport layer 220-b according to a protocol (e.g., a UniPro protocol). For example, the memory system 210 may receive symbols of packets associated with the access command from the host system via the physical interface 225-b according to an associated physical protocol (e.g., M-PHY), and the transport layer 220-b may associate the packets with a stream for access commands. The command interconnect layer 215-b may translate the access command to the protocol of the storage command interface 230-b prior to the memory system controller 280 performing operations associated with the access command. The memory system 210 may include a buffer 285 for temporary storage of data being transferred between the host system 205 and the memory devices 235. For example, in response to the access command, the memory system controller 280 may perform an associated access operation. In the case that multiple access commands may be received at the memory system 210, the memory system 210 may use the buffer 285 to temporarily store data during transfers which may allow data to be buffered while commands are being processed and thus may reduce latency between commands and may support arbitrary data sizes associated with commands.

The memory system 210 may include a storage device interface 290. The storage device interface 290 may be used in accessing the memory devices 235 in response to access commands. In some examples, the memory system controller 280 may use the storage device interface 290 to map (e.g., organize, associate) addresses in volatile memory of the memory system controller 280 (e.g., buffer 285) to addresses within the memory devices 235 to simplify access operations. For example, in response to receiving the access command, the memory system controller 280 may use information stored to the buffer 285 (e.g., logical to physical mapping information) to access an associated memory device 235. The storage device interface 290 may also communicate with the buffer 285 to retrieve data for storage into the memory devices 235 or to buffer data from the memory devices 235 for communication to the host system 205.

The memory system 210 may include error logs that may store details of transactions (e.g., command reception information, command response data) at various layers and interfaces within the memory system 210 for each command received from the host system 205. For example, the memory system 210 may include a command log (e.g., a SCSI log) to track types of errors that may occur at the memory system 210 and associated commands. In the case that the memory system 210 may detect an error, the memory system 210 may store details regarding the error to the log to be used in various recovery operations. While storage of details of system errors (e.g., errors at the storage command interface 230, errors at the command interconnect layer 215) at the memory system 210 may be beneficial in recovering data at the memory system 210, some types of information may not be stored. For example, while the memory system 210 may store storage command interface error information and command interconnect layer error information, it may be difficult to correctly align storage command interface errors (e.g., SCSI command errors) with corresponding operations at the transport layer 220-b when determining causes of errors at the memory system 210 or when performing recovery operations.

In some examples, the memory system 210 may compare error logs stored at the associated host system 205 and command logs at the memory system 210 to detect problems that may lead to errors at the memory system 210 (e.g., at the storage command interface 230-b), determine the cause of errors, or both. However, comparing logs may supply the memory system 210 with minimal information. For example, the memory system 210 may be unable to determine enough information from the logs stored to the host system 205 and the logs at the memory system 210 to determine a cause of an error or to perform effective recovery operations. Without sufficient information, the memory system 210 may be unable to map various commands to operations during error detection, may use a large quantity of time during recovery operations, or a combination thereof.

To increase speed of recovery operations and efficiency at the memory system 210, a trace log 275 may be implemented at the memory system 210 to collect operation history and command (e.g., and command response) information of the memory system 210. For example, during communication of commands and data between the host system 205 and the memory system 210 via various layers (e.g., the transport layer 220-b, the storage command interface 230-b) and different interfaces (e.g., the physical interface 225-b) of the memory system 210, the memory system 210 may collect information associated with transactions at one or more of the various layers and interfaces. For example, the memory system 210 may store transaction information associated with packets communicated at the transport layer 220 and transaction information associated with access commands (e.g., and responses) communicated at the storage command interface 230-b in the trace log 275. In some cases the trace log 275 may include two buffers (e.g., ping-pong buffers), and the memory system 210 may store command history (e.g., commands, command responses), error details, and other information associated with the storage command interface 230-b (e.g., as communicated via the command interconnect layer 215-b) in an active (e.g., current) buffer of the trace log 275. The active buffer may also store transaction information associated with packets (e.g., which are associated with the commands and responses) communicated via the transport layer 220-b.

The memory system 210 may store the various information to the trace log 275 according to a timing based on a clock of the physical interface 225-b. For example, the memory system 210 may store timing details to the trace log 275 along with the transaction information. The memory system 210 may continue to store transaction information and an aligned timestamp to the active buffer of the trace log 275 until the memory system 210 detects a trigger. In the case that a trigger is detected, the memory system 210 may transfer (e.g., flush) the contents of the trace log 275 to one or more of the memory devices 235. For example, in response to a trigger, the memory system 210 may pause the active buffer of the trace log 275 and may transfer the information stored to the buffer to the memory devices 235 (e.g., perform a flush operation). For the duration one buffer of the trace log 275 is paused, the other buffer may receive and store information. In addition, when one buffer is full the buffer may be flushed while the other buffer is activated. The memory system 210 may use the information captured to the trace log 275 (e.g., the transaction information, the timing data) and flushed to the memory devices 235 during the flush operation in diagnostic or recovery operations at the memory system 210 (or retrieved by the host system 205).

The trace log 275 may include multiple storage components, and may be at least partially implemented using buffer 285. For example, the trace log 275 may include a first set of registers to receive information from the transport layer 220-b, and a second set of registers to receive information from the command interconnect layer 215-b or the storage command interface 230-b, such that the transaction information may be stored asynchronously when it occurs and potentially at the same time or almost at the same time (e.g., the first and second sets of registers may receive transaction information concurrently or separated by only small numbers of clock cycles). The first and second sets of registers may have limited capacity, and the information in the first and second set of registers may be moved to the buffer 285 (e.g., by the memory system controller 280) when they reach capacity (and may be read when the active buffer of the trace log 275 is flushed to flush all transaction information associated with the active buffer). The memory system controller 280 may sort the transaction information according to the timestamps, such that the transaction information associated with the commands (e.g., from the command interconnect layer 215-b or the storage command interface 230-b) may be interleaved in the trace log 275 with the transaction information associated with packets communicated via the transport layer 220-b.

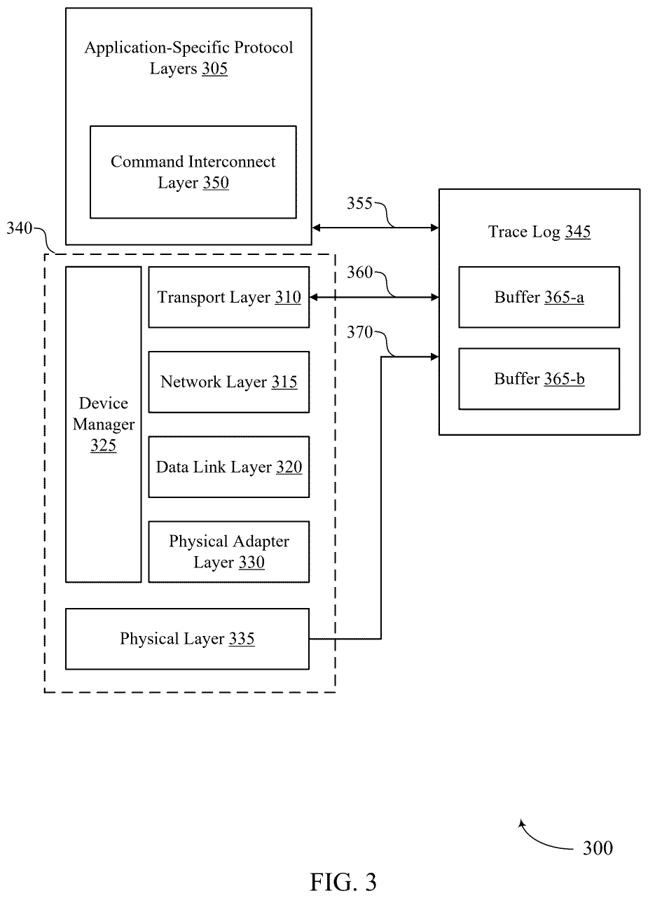

FIG. 3 shows an example of a protocol stack 300 that supports trace log for tracking of multi-layer command processing in accordance with examples as disclosed herein. The protocol stack 300 may illustrate aspects of a system 100, a system 200, or both, as described with reference to FIGS. 1 and 2. The protocol stack 300 may be implemented in a memory system configured to store data received from a host system and to send data to the host system, if requested by the host system using access commands (e.g., read commands or write commands). For example, the protocol stack 300 may include a command interconnect layer 350, a transport layer 310, a physical layer 335, and may illustrate connection of various layers with a trace log 345. These may be examples of a command interconnect layer 215, a transport layer 220, a physical interface 225, and a trace log 275 as described with reference to FIG. 2, respectively.

The protocol stack 300 may include one or more layers and interfaces associated with or included in a UniPro stack 340. The UniPro stack 340 may include a device manager 325. The memory system may use the device manager 325 to control one or more layers and interfaces of the UniPro stack 340. For example, the device manager 325 may assist in power-down operations, boot-up operations, reset operations, and in other power transitions associated with the UniPro stack 340.

The UniPro stack 340 may include a physical layer 335. The physical layer 335 may be implemented in a physical interface including one or more data channels (e.g., physical lanes such as differential signaling) and a clock to manage timing of symbol information.

Above the physical layer 335, the UniPro stack 340 may include a physical adapter layer 330, a data link layer 320, a network layer 315, a transport layer 310, or a combination thereof. The physical adapter layer 330 may be configured to adapt a format (e.g., type) of the physical layer 335 to best fit requirements of the memory system. For example, the memory system may use the physical adapter layer 330 to adapt power states, encoding schemes, and other aspects of the physical layer 335. The data link layer 320 may be configured to perform flow control in the case of bit errors and form frames of bytes communicated via the physical layer 335. For example, the data link layer 320 may manage data buffer space and perform retransmissions for symbols or frames with errors, and thus increase data communication reliability. The network layer 315 may be configured to route data packets through the memory system by attaching data headers to packets receive from the data link layer 320.

The UniPro stack 340 may include the transport layer 310. The transport layer 310 may be configured to accept data packets from the network layer 315 and perform various addressing, packet division operations, or other communication operations prior to transferring the data to a destination in the memory system. As described herein, when a command (e.g., data packet associated with a command) is received at the transport layer 310, the memory system may store details of the transactions associated with the command in one of the buffers 365 of the trace log 345 via a connection 360. The memory system may store the transaction details in one or more active buffers 365. For example, the trace log 345 may include two buffers (e.g., buffer 365-a, buffer 365-b), one of which may be active at a time for storing transaction information. The transaction information may be information related to packets, or other details of the operations at the transport layer 310. The memory system may store the transaction details generated by the transport layer 310 at the trace log 345 via the connection 360 according to (e.g., along with) the timing information 370 generated at the physical layer 335. For example, each stored transaction may be associated with a timestamp generating from the timing information 370. Although discussed as storing information related to transactions at the transport layer 310, the trace log 345 may store information from other layers of the UniPro stack 340 such as the network layer 315 or data link layer 320. For example, flow control information such as retransmissions from the network layer 315 may be stored in the trace log 345.

The protocol stack 300 may include application-specific protocol layers 305. The application-specific protocol layers 305 may process information related to protocols used by an application layer of the memory system. For example, the application-specific protocol layers 305 may include a storage command layer (e.g., associated with a storage command interface such as SCSI or UFS). The application-specific protocol layers 305 may include the command interconnect layer 350 (e.g., UIC layer). The memory system may use the command interconnect layer 350 to manage the UniPro stack 340. For example, the command interconnect layer 350 may translate packets received from the transport layer 310 to commands for processing by the application-specific protocol layers 305. As described herein, when a command (e.g., packets associated with a command) is received at the command interconnect layer 350, the memory system may store details of the transactions associated with the command in one of the buffers 365 (e.g., active buffer) of the trace log 345 via a connection 355. The transaction details may be the command, a type of the command, a command response, an indication of an error at the command interconnect layer 350, a type of the error, or other details of the operations at the command interconnect layer 350. The memory system may store the transaction details generated by the command interconnect layer 350 at the trace log 345 via the connection 355 according to (e.g., along with) the timing information 370 (e.g., timestamp) generated at the physical layer 335.

Use of the trace log 345 may enable the memory system to store information associated with operation history of various layers and interfaces of the UniPro stack 340 and application-specific protocol layers 305 and related timing details in a single log. Storing such details at the trace log 345 may enable the memory system to quickly and efficiently determine causes of errors and effectively perform recovery operations without accessing multiple data logs, without accessing data stored to the host system, or performing other time-consuming access operations. Use of a trace log 345 may thus decrease error recovery time and increase processing efficiency at the memory system.

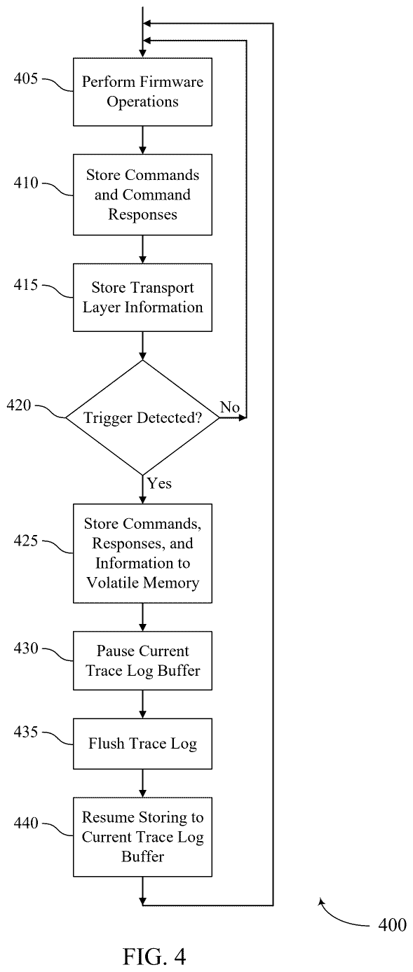

FIG. 4 shows an example of a process flow 400 that supports trace log for tracking of multi-layer command processing in accordance with examples as disclosed herein. The operations of process flow 400 may be performed by a memory system or one or more controllers associated with a memory system as described herein. For example, the operations of process flow 400 may be performed by a memory system 110, a memory system 210, or a controller thereof as described with reference to FIGS. 1 and 2. The process flow 400 may also include reference to a trace log, which may be an example of a trace log 275 or a trace log 345 as described with reference to FIGS. 2 and 3. The process flow 400 may also include reference to a command interconnect layer, a storage command interface, a transport layer, and a physical interface, which may be examples of a command interconnect layer 215 or a command interconnect layer 350, a storage command interface 230, a transport layer 220 or a transport layer 310, and a physical interface 225 or a physical layer 335, as described with reference to FIGS. 2 and 3.

At 405, firmware operations may be performed. A memory system may perform one or more firmware operations (e.g., one or more access operations, one or more background operations). For example, the memory system may communicate one or more commands via a storage command interface of a memory system that may support SCSI protocol commands. Communicating the commands via the storage command interface may include the memory system communicating one or more packets via a transport layer that may be coupled with the storage command interface via a command interconnect layer. In some examples, the transport layer may communicate the one or more packets via a physical interface. The physical interface may include a data clock and one or more serial data lanes.

At 410, commands, command responses, or a combination thereof may be stored. In response to communicating the one or more commands, the memory system may store log data to a trace log of the memory system. In some examples, the log data may be associated with one or more transactions (e.g., commands, responses) associated with the one or more commands at the command interconnect layer. The log data may indicate timing of the transactions according to a timing associated with the data clock of the physical interface. In some examples, the log data may also include one or more SCSI commands, one or more SCSI responses, or a combination thereof.

At 415, transport layer information may be stored. In response to communicating the one or more commands, the memory system may also store second log data to the trace log of the memory system. In some examples, the second log data may be associated with one or more transactions (e.g., packets) associated with the one or more commands at the transport layer. The second log data may indicate timing of the second transactions according to the timing associated with the data clock of the physical interface. In some examples, the second log data may also include state data, error data, or a combination thereof, associated with the transport layer. The memory system may sequentially store the log data and the second log data to the trace log (e.g., in order of the timing information).

At 420, a trigger may be evaluated. In some examples, the trigger may be an error associated with the storage command interface, and detecting whether a trigger exists includes the memory system determining whether an error may be associated with or in the storage command interface. In some other examples, the trigger may be a time-out event at the command interconnect layer or a time-out event associated with a command of the one or more commands, and detecting whether a trigger exists includes the memory system determining whether a time-out event has occurred. For example, the memory system may not detect a trigger (e.g., an error at the storage command interface, a time-out event at the command interconnect layer or associated with a command) at 420 and may continue to perform firmware operations at 405 in response to not detecting a trigger. In other examples, the memory system may detect a trigger (e.g., an error at the storage command interface, a time-out event at the command interconnect layer or associated with a command) at 420, and may initiate one or flushing operations that may begin with the memory system storing commands, command responses, and system information to volatile memory of the memory system at 425.

At 425, commands, command responses, and system information may be stored. For example, in response to detecting a trigger, the memory system may store the contents of the trace log (e.g., the log data and the second log data) to non-volatile memory of the memory system.

At 430, a current trace log buffer may be paused. In some examples, the trace log may include two buffers. In response to detecting a trigger, the memory system may pause storing the first log data and the second log data in a first buffer of the trace log for a duration. In some examples, at least a portion of the duration may be associated with performance of a flush operation.

At 435, the trace log may be flushed. In response to pausing the first buffer of the trace log, and in response to detecting the trigger, the memory system may perform the flush operation to transfer the log data and the second log data from the trace log to non-volatile memory of the memory device. In some examples, during at least a portion of the duration during which the memory system performs the flush operation, the memory system may store log data (e.g., a portion of the log data, a portion of the second log data) to a second buffer of the trace log.

At 440, storing to the current trace log may be resumed. For example, in response to performing the flush operation and after the duration (e.g., when the second buffer is full), the memory system may resume storing log data (e.g., the log data, the second log data) to the first buffer of the trace log (e.g., and may flush the second buffer to the non-volatile memory).

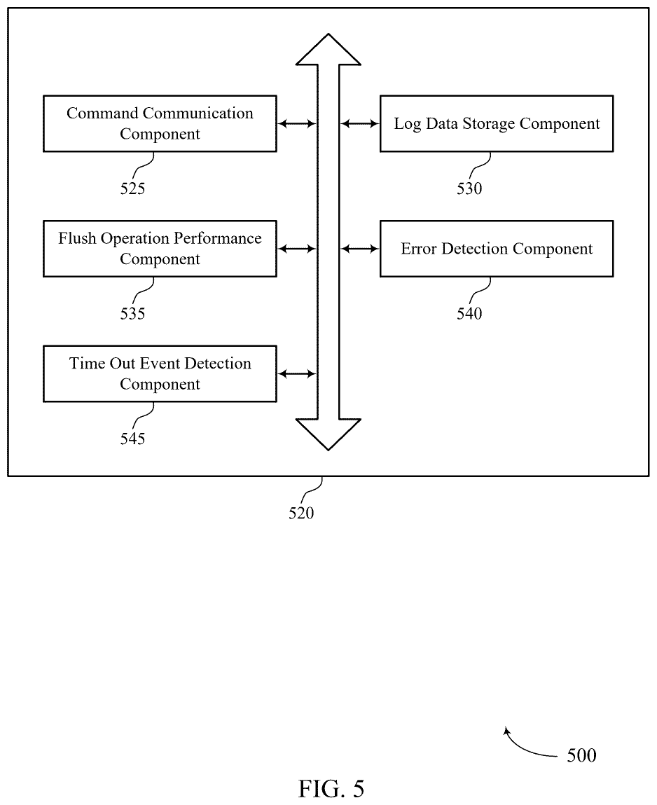

FIG. 5 shows a block diagram 500 of a memory system 520 that supports trace log for tracking of multi-layer command processing in accordance with examples as disclosed herein. The memory system 520 may be an example of aspects of a memory system as described with reference to FIGS. 1 through 4. The memory system 520, or various components thereof, may be an example of means for performing various aspects of trace log for tracking of multi-layer command processing as described herein. For example, the memory system 520 may include a command communication component 525, a log data storage component 530, a flush operation performance component 535, an error detection component 540, a time out event detection component 545, or any combination thereof. Each of these components, or components of subcomponents thereof (e.g., one or more processors, one or more memories), may communicate, directly or indirectly, with one another (e.g., via one or more buses).

The command communication component 525 may be configured as or otherwise support a means for communicating one or more commands via a storage command interface of a memory device, where communicating the one or more commands via the storage command interface includes communicating one or more packets via a transport layer that is coupled with the storage command interface via a command interconnect layer, and where the transport layer communicates the one or more packets via a physical interface including a data clock. The log data storage component 530 may be configured as or otherwise support a means for storing, in a trace log of the memory device in response to communicating the one or more commands, first log data corresponding to first transactions associated with the one or more commands at the transport layer and second log data corresponding to second transactions associated with the one or more commands at the command interconnect layer, where the first log data and the second log data indicate timing of the first transactions and the second transactions, respectively, according to a timing associated with the data clock of the physical interface.

In some examples, the flush operation performance component 535 may be configured as or otherwise support a means for performing, in response to storing the first log data and the second log data to the trace log, a flush operation to transfer the first log data and the second log data from the trace log to non-volatile memory of the memory device, where performing the flush operation is performed in response to a trigger.

In some examples, the trigger includes an error associated with the storage command interface, and the error detection component 540 may be configured as or otherwise support a means for detecting the error associated with the storage command interface.

In some examples, the trigger includes a time out event at the command interconnect layer or associated with a command of the one or more commands, and the time out event detection component 545 may be configured as or otherwise support a means for detecting the time out event, where performing the flush operation is in response to detecting the time out event.

In some examples, the log data storage component 530 may be configured as or otherwise support a means for pausing storing the first log data and the second log data in a first buffer of the trace log for a duration, where at least a portion of the duration is associated with performance of the flush operation. In some examples, the log data storage component 530 may be configured as or otherwise support a means for storing, during the duration, a portion of the first log data and a portion of the second log data in a second buffer of the trace log. In some examples, the log data storage component 530 may be configured as or otherwise support a means for resuming storing the first log data and the second log data in the first buffer of the trace log after the duration.

In some examples, the first log data includes state data, error data, or a combination thereof, associated with the transport layer; and the second log data includes one or more SCSI commands, one or more SCSI responses, or a combination thereof.

In some examples, the first log data and the second log data are sequentially stored to the trace log.

In some examples, the storage command interface supports SCSI protocol commands.

In some examples, the physical interface includes one or more serial data lanes.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

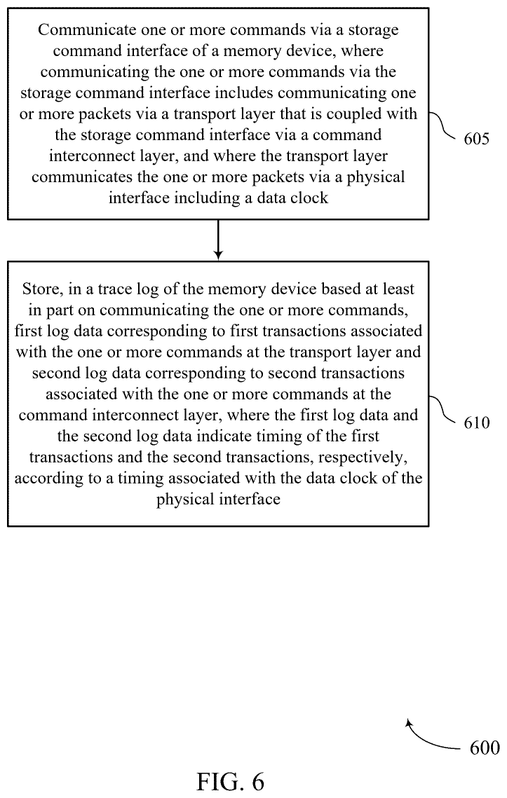

FIG. 6 shows a flowchart illustrating a method 600 that supports trace log for tracking of multi-layer command processing in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include communicating one or more commands via a storage command interface of a memory device, where communicating the one or more commands via the storage command interface includes communicating one or more packets via a transport layer that is coupled with the storage command interface via a command interconnect layer, and where the transport layer communicates the one or more packets via a physical interface including a data clock. In some examples, aspects of the operations of 605 may be performed by a command communication component 525 as described with reference to FIG. 5.

At 610, the method may include storing, in a trace log of the memory device in response to communicating the one or more commands, first log data corresponding to first transactions associated with the one or more commands at the transport layer and second log data corresponding to second transactions associated with the one or more commands at the command interconnect layer, where the first log data and the second log data indicate timing of the first transactions and the second transactions, respectively, according to a timing associated with the data clock of the physical interface. In some examples, aspects of the operations of 610 may be performed by a log data storage component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for communicating one or more commands via a storage command interface of a memory device, where communicating the one or more commands via the storage command interface includes communicating one or more packets via a transport layer that is coupled with the storage command interface via a command interconnect layer, and where the transport layer communicates the one or more packets via a physical interface including a data clock and storing, in a trace log of the memory device in response to communicating the one or more commands, first log data corresponding to first transactions associated with the one or more commands at the transport layer and second log data corresponding to second transactions associated with the one or more commands at the command interconnect layer, where the first log data and the second log data indicate timing of the first transactions and the second transactions, respectively, according to a timing associated with the data clock of the physical interface.
Aspect 2: The method, apparatus, or non-transitory computer-readable medium of aspect 1, further including operations, features, circuitry, logic, means, or instructions, or any combination thereof for performing, in response to storing the first log data and the second log data to the trace log, a flush operation to transfer the first log data and the second log data from the trace log to non-volatile memory of the memory device, where performing the flush operation is performed in response to a trigger.
Aspect 3: The method, apparatus, or non-transitory computer-readable medium of aspect 2, where the trigger includes an error associated with the storage command interface and the method, apparatuses, and non-transitory computer-readable medium further includes operations, features, circuitry, logic, means, or instructions, or any combination thereof for detecting the error associated with the storage command interface.
Aspect 4: The method, apparatus, or non-transitory computer-readable medium of any of aspects 2 through 3, where the trigger includes a time out event at the command interconnect layer or associated with a command of the one or more commands and the method, apparatuses, and non-transitory computer-readable medium further includes operations, features, circuitry, logic, means, or instructions, or any combination thereof for detecting the time out event, where performing the flush operation is in response to detecting the time out event.
Aspect 5: The method, apparatus, or non-transitory computer-readable medium of any of aspects 2 through 4, further including operations, features, circuitry, logic, means, or instructions, or any combination thereof for pausing storing the first log data and the second log data in a first buffer of the trace log for a duration, where at least a portion of the duration is associated with performance of the flush operation; storing, during the duration, a portion of the first log data and a portion of the second log data in a second buffer of the trace log; and resuming storing the first log data and the second log data in the first buffer of the trace log after the duration.
Aspect 6: The method, apparatus, or non-transitory computer-readable medium of any of aspects 1 through 5, where the first log data includes state data, error data, or a combination thereof, associated with the transport layer; and the second log data includes one or more SCSI commands, one or more SCSI responses, or a combination thereof.
Aspect 7: The method, apparatus, or non-transitory computer-readable medium of any of aspects 1 through 6, where the first log data and the second log data are sequentially stored to the trace log.
Aspect 8: The method, apparatus, or non-transitory computer-readable medium of any of aspects 1 through 7, where the storage command interface supports SCSI protocol commands.
Aspect 9: The method, apparatus, or non-transitory computer-readable medium of any of aspects 1 through 8, where the physical interface includes one or more serial data lanes.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
communicate one or more commands via a storage command interface of a memory device, wherein communicating the one or more commands via the storage command interface comprises communicating one or more packets via a transport layer that is coupled with the storage command interface via a command interconnect layer, and wherein the transport layer communicates the one or more packets via a physical interface comprising a data clock; and
store, in a trace log of the memory device in response to communicating the one or more commands, first log data corresponding to first transactions associated with the one or more commands at the transport layer and second log data corresponding to second transactions associated with the one or more commands at the command interconnect layer, wherein the first log data and the second log data indicate timing of the first transactions and the second transactions, respectively, according to a timing associated with the data clock of the physical interface.

2. The apparatus of claim 1, wherein the processing circuitry is further configured to cause the apparatus to:
perform, in response to storing the first log data and the second log data to the trace log, a flush operation to transfer the first log data and the second log data from the trace log to non-volatile memory of the memory device, wherein performing the flush operation is performed in response to a trigger.

3. The apparatus of claim 2, wherein the trigger comprises an error associated with the storage command interface, and the processing circuitry is further configured to cause the apparatus to:
detect the error associated with the storage command interface.

4. The apparatus of claim 2, wherein the trigger comprises a time out event at the command interconnect layer or associated with a command of the one or more commands, and the processing circuitry is further configured to cause the apparatus to:
detect the time out event, wherein performing the flush operation is in response to detecting the time out event.

5. The apparatus of claim 2, wherein the processing circuitry is further configured to cause the apparatus to:
pause storing the first log data and the second log data in a first buffer of the trace log for a duration, wherein at least a portion of the duration is associated with performance of the flush operation;
store, during the duration, a portion of the first log data and a portion of the second log data in a second buffer of the trace log; and
resume storing the first log data and the second log data in the first buffer of the trace log after the duration.

6. The apparatus of claim 1, wherein:
the first log data comprises state data, error data, or a combination thereof, associated with the transport layer; and
the second log data comprises one or more small computer system interface (SCSI) commands, one or more SCSI responses, or a combination thereof.

7. The apparatus of claim 1, wherein the first log data and the second log data are sequentially stored to the trace log.

8. The apparatus of claim 1, wherein the storage command interface supports small computer system interface (SCSI) protocol commands.

9. The apparatus of claim 1, wherein the physical interface comprises one or more serial data lanes.

10. A non-transitory computer-readable medium storing code, the code comprising instructions executable by one or more processors to:
communicate one or more commands via a storage command interface of a memory device, wherein communicating the one or more commands via the storage command interface comprises communicating one or more packets via a transport layer that is coupled with the storage command interface via a command interconnect layer, and wherein the transport layer communicates the one or more packets via a physical interface comprising a data clock; and
store, in a trace log of the memory device in response to communicating the one or more commands, first log data corresponding to first transactions associated with the one or more commands at the transport layer and second log data corresponding to second transactions associated with the one or more commands at the command interconnect layer, wherein the first log data and the second log data indicate timing of the first transactions and the second transactions, respectively, according to a timing associated with the data clock of the physical interface.

11. The non-transitory computer-readable medium of claim 10, wherein the instructions are further executable by the one or more processors to:
perform, in response to storing the first log data and the second log data to the trace log, a flush operation to transfer the first log data and the second log data from the trace log to non-volatile memory of the memory device, wherein performing the flush operation is performed in response to a trigger.

12. The non-transitory computer-readable medium of claim 11, wherein the trigger comprises an error associated with the storage command interface, and the instructions are further executable by the one or more processors to:
detect the error associated with the storage command interface.

13. The non-transitory computer-readable medium of claim 11, wherein the trigger comprises a time out event at the command interconnect layer or associated with a command of the one or more commands, and the instructions are further executable by the one or more processors to:
detect the time out event, wherein performing the flush operation is in response to detecting the time out event.

14. The non-transitory computer-readable medium of claim 11, wherein the instructions are further executable by the one or more processors to:
pause storing the first log data and the second log data in a first buffer of the trace log for a duration, wherein at least a portion of the duration is associated with performance of the flush operation;
store, during the duration, a portion of the first log data and a portion of the second log data in a second buffer of the trace log; and
resume storing the first log data and the second log data in the first buffer of the trace log after the duration.

15. The non-transitory computer-readable medium of claim 10, wherein:
the first log data comprises state data, error data, or a combination thereof, associated with the transport layer; and
the second log data comprises one or more small computer system interface (SCSI) commands, one or more SCSI responses, or a combination thereof.

16. The non-transitory computer-readable medium of claim 10, wherein the first log data and the second log data are sequentially stored to the trace log.

17. The non-transitory computer-readable medium of claim 10, wherein the storage command interface supports small computer system interface (SCSI) protocol commands.

18. The non-transitory computer-readable medium of claim 10, wherein the physical interface comprises one or more serial data lanes.

19. A method, comprising:
communicating one or more commands via a storage command interface of a memory device, wherein communicating the one or more commands via the storage command interface comprises communicating one or more packets via a transport layer that is coupled with the storage command interface via a command interconnect layer, and wherein the transport layer communicates the one or more packets via a physical interface comprising a data clock; and
storing, in a trace log of the memory device in response to communicating the one or more commands, first log data corresponding to first transactions associated with the one or more commands at the transport layer and second log data corresponding to second transactions associated with the one or more commands at the command interconnect layer, wherein the first log data and the second log data indicate timing of the first transactions and the second transactions, respectively, according to a timing associated with the data clock of the physical interface.

20. The method of claim 19, further comprising:
performing, in response to storing the first log data and the second log data to the trace log, a flush operation to transfer the first log data and the second log data from the trace log to non-volatile memory of the memory device, wherein performing the flush operation is performed in response to a trigger.

21. The method of claim 20, wherein the trigger comprises an error associated with the storage command interface, the method further comprising:
detecting the error associated with the storage command interface.

22. The method of claim 20, wherein the trigger comprises a time out event at the command interconnect layer or associated with a command of the one or more commands, the method further comprising:
detecting the time out event, wherein performing the flush operation is in response to detecting the time out event.
